(19) United States
(12) Patent Application Publication
(10) Pub. No.: US 2016/0178959 A1
(43) Pub. Date: Jun. 23, 2016

(54) BOA Substrate and Method of Forming the Same

(71) Applicant: SHENZHEN CHINA STAR OPTOELECTRONICS TECHNOLOGY CO., LTD., Guangdong (CN)

(72) Inventors: Yong Xu, Guangdong (CN); Yuan Xiong, Guangdong (CN)

(21) Appl. No.: 14/417,103

(22) PCT Filed: Jan. 12, 2015
(86) PCT No.: PCT/CN2015/070495

§ 371 Date: Jan. 23, 2015

(30) Foreign Application Priority Data
Dec. 22, 2014 (CN) 201410805404.8

(51) Int. Cl. G02F 1/1335; G02B 5/20; G02B 5/00

(52) U.S. Cl. CPC G02F 1/133512; G02B 5/003; G02B 5/201; G02F 1/133516

(57) ABSTRACT

A method of forming a BOA substrate includes forming an array substrate comprising a display area and a non-display area; coating a black matrix in the display area of the array substrate, and patterning the black matrix; and installing photoresist on the array substrate. The present invention also proposes a BOA substrate. The method of forming the BOA substrate enhance the quality of the BOA substrate, and further influence the display quality of LCD panels.

### BACKGROUND OF THE INVENTION

1. Field of the Invention

The present invention relates to liquid crystal display (LCD) technology, and more specifically, to a method of forming a black matrix on array (BOA) substrate and the BOA substrate.

2. Description of the Prior Art

Black matrix on array (BOA) is a technique that can reduce misalignment when two substrates are being assembled, increase the aperture ratio of a liquid crystal display (LCD) panel, and lower the parasitic capacitance of the LCD panel. Therefore BOA is widely applied in the production of LCD panels.

When a black matrix is exposed during the process of forming the black matrix on an array substrate, a misalignment of the array substrate and the black matrix is likely to occur, given the fact that the black matrix is opaque. It affects the quality of a BOA substrate thus produced, and further influences the display quality of the LCD panel.

Therefore, it is necessary to provide a method of forming a BOA substrate and the BOA substrate to solve the existing technical problem.

### SUMMARY OF THE INVENTION

An object of the present invention is to provide a BOA substrate, which is less likely to cause misalignment of an array substrate and a color filter, and a method of forming the same, so to solve the technical problem with conventional BOA substrates which is more likely to cause misalignment of the array substrate and the color filter, and further influence the display quality of LCD panels.

According to a present invention, a method of forming a black matrix on array (BOA) substrate, comprises: forming an array substrate, wherein the array substrate comprises a display area and a non-display area, which is installed with a metal layer to prevent light leakage in the non-display area; and coating a black matrix in the display area and patterning the black matrix.

In one aspect of the present invention, after patterning the black matrix the method further comprises coating a photoresist layer on the array substrate and patterning the photoresist layer so to form a photoresist on the array substrate.

In another aspect of the present invention, wherein the photoresist comprises red photoresist, blue photoresist and green photoresist.

In another aspect of the present invention, the step of coating photoresist on the array substrate comprises installing the photoresist to shield light in the non-display area of the array substrate.

In another aspect of the present invention, the photoresist to shield light is a layered structure of red photoresist, green photoresist and blue photoresist.

In still another aspect of the present invention, the photoresist to shield light is a layered structure of red photoresist and blue photoresist.

In yet another aspect of the present invention, the photoresist to shield light is a layered structure of red photoresist and green photoresist.

According to the present invention, a method of forming a BOA substrate, comprises: forming an array substrate comprising a display area and a non-display area; coating a black matrix in the display area of the array substrate, and patterning the black matrix; and installing photoresist on the array substrate, wherein the photoresist is installed in the non-display area of the array substrate shields light and prevents light leakage in the non-display area.

In one aspect of the present invention, wherein the step of installing photoresist on the array substrate comprises coating a photoresist layer on the array substrate, and patterning the photoresist layer so to form a photoresist on the array substrate.

In another aspect of the present invention, the photoresist comprises red photoresist, blue photoresist and green photoresist.

In another aspect of the present invention, the photoresist to shield light is a layered structure of red photoresist, green photoresist and blue photoresist.

In still another aspect of the present invention, the photoresist to shield light is a layered structure of red photoresist and blue photoresist.

In yet another aspect of the present invention, the photoresist to shield light is a layered structure of red photoresist and green photoresist.

According the present invention, a BOA substrate, comprises an array substrate and a black matrix. The array substrate comprises a display area to show images and a non-display area to separate different pixels. The black matrix, is installed in the display area of the array substrate to absorb light emitted from the non-display area of the array substrate. The non-display area of the array substrate is installed with a metal layer to prevent light leakage in the non-display area.

In another aspect of the present invention, the BOA substrate further comprises a photoresist layer and a light-shielding color resist layer. The photoresist layer comprises red photoresist, blue photoresist and green photoresist, installed in the display area of the array substrate to transform the light emitted from the BOA substrate into various monochromatic lights. The light-shielding color resist layer is installed on the metal layer in the non-display area of the array substrate.

In another aspect of the present invention, the light-shielding color resist layer is a layered structure of red photoresist, green photoresist and blue photoresist.

In still another aspect of the present invention, the light-shielding color resist layer is a layered structure of red photoresist and blue photoresist.

In yet another aspect of the present invention, light-shielding color resist layer is a layered structure of red photoresist and green photoresist.

Comparing with the conventional forming method of BOA substrates and conventional BOA substrates, the method of forming the BOA substrate and the BOA substrate of the present invention installs a black matrix only in a display area of the array substrate, thus is less likely to cause misalignment of the array substrate and the color filter. It solves the technical problem with the conventional method of forming BOA substrates and conventional BOA substrates, which is more likely to cause misalignment of the array substrate and the color filter, and further influence the display quality of LCD panels.

These and other features, aspects and advantages of the present disclosure will become understood with reference to the following description, appended claims and accompanying figures.

### BRIEF DESCRIPTION OF THE DRAWINGS

FIG. 1 shows a flow chart of the method of forming the BOA substrate according to a first preferred embodiment of the present invention.

FIG. 2 shows a flow chart of the method of forming the BOA substrate according to a second preferred embodiment of the present invention.

FIG. 3 shows a flow chart of the method of forming the BOA substrate according to a third preferred embodiment of the present invention.

FIG. 4A is a diagram of the BOA substrate according to the first preferred embodiment of the present invention.

FIG. 4B shows a cross-sectional view along a line A-A′.

FIG. 5A shows a diagram of a BOA substrate according to a second preferred embodiment of the present invention.

FIG. 5B is a cross-sectional view along a line B-B′ in FIG. 5A.

FIG. 6A is a diagram of the BOA substrate according to a third preferred embodiment of the present invention.

FIG. 6B is a cross-sectional view along a line C-C′ in FIG. 6A.

### DETAILED DESCRIPTION OF PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

It is noted that the same components are labeled by the same number.

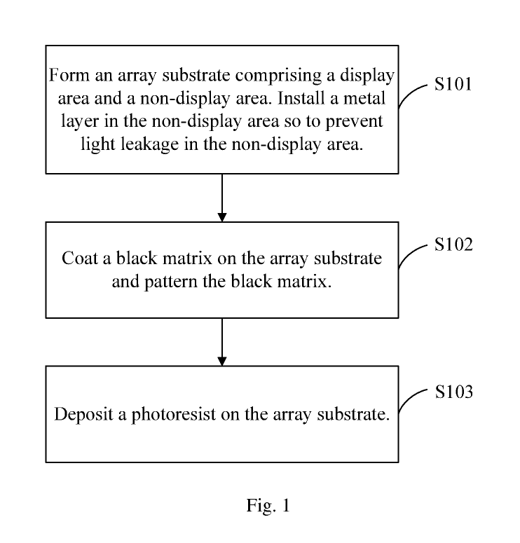

Please refer to FIG. 1, showing a flow chart of the method of forming the BOA substrate according to a first preferred embodiment of the present invention. The method of forming the BOA substrate of the present preferred embodiment comprises:

Step S101: Form an array substrate comprising a display area and a non-display area. Install a metal layer in the non-display area so to prevent light leakage in the non-display area.

Step S102: Coat a black matrix on the array substrate and pattern the black matrix.

Step S103: Deposit a photoresist on the array substrate.

A more specific explanation of steps of the method forming the BOA substrate of the present preferred embodiment is provided in the following text.

In the step S101, form an array substrate, which may comprise data lines, scan lines, thin film transistors and pixel electrodes. The array substrate comprises a display area to show images and a non-display area to distinguish or separate different pixels. When a metal layer is applied to form the data line or scan line of the array substrate, the same metal layer is also installed in the non-display area on the array substrate, such as a first metal layer of the data line and a second metal layer of the scan line. It can block light from leaking from the non-display area, so to prevent light leakage. Then take step S102.

In the step S102, a slit coating machine is used to coat the black matrix in the display area of the array substrate, so that the photolithography machine can align the black matrix area through the non-display area of the array substrate and undertake an accurate patterning of the black matrix. Then take step S103.

In the step S103, install photoresist in the display area of the array substrate. More specifically, a layer of photoresist is coated on the array substrate, and then patterned by a corresponding lithographic photomask, so to form a corresponding photoresist in the display area of the array substrate. The photoresist comprises red photoresist, blue photoresist and green photoresist. The photoresist can also be installed directly on a substrate to be assembled with the array substrate, so that the two substrates can form a liquid crystal cell.

This concludes the method forming the BOA substrate of the present preferred embodiment.

Given that the black matrix is only installed in the display area of the array substrate, it is easy to pattern the black matrix and install corresponding photoresist. Meanwhile, the metal layer installed in the non-display area of the array substrate can effectively block the light from the back light source to leak from the non-display area, so to prevent light leakage.

The method forming the BOA substrate of the present preferred embodiment installs the black matrix only in the display area of the BOA substrate, so it is less likely to cause misalignment of the array substrate and color filter. And, the metal layer installed in the non-display area of the BOA substrate prevents light leakage.

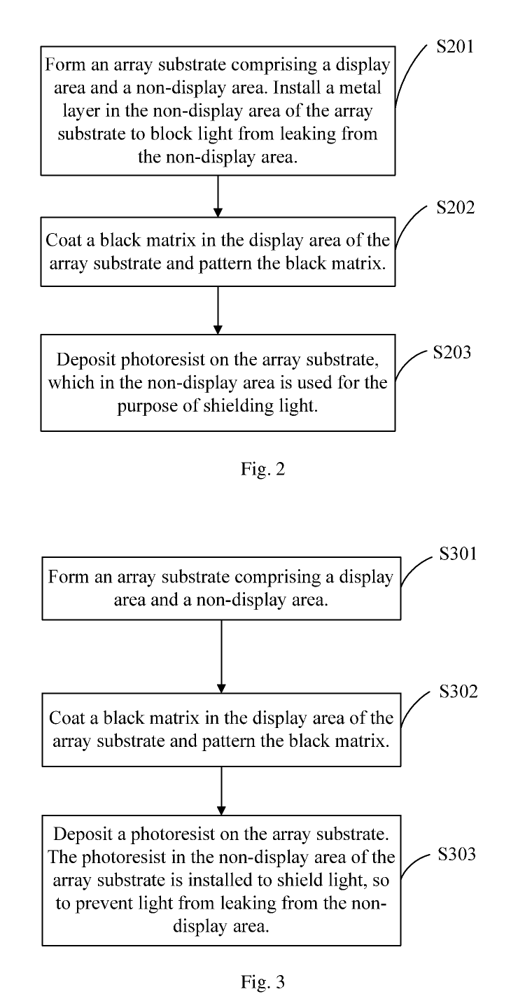

Please refer to FIG. 2, showing a flow chart of the method of forming the BOA substrate according to a second preferred embodiment of the present invention. The method of forming the BOA substrate of the present preferred embodiment comprises:

Step S201: Form an array substrate comprising a display area and a non-display area. Install a metal layer in the non-display area of the array substrate to block light from leaking from the non-display area.

Step S202: Coat a black matrix in the display area of the array substrate and pattern the black matrix.

Step S203: Deposit photoresist on the array substrate, which in the non-display area is used for the purpose of shielding light.

A specific explanation of steps of the method forming the BOA substrate of the present preferred embodiment is provided in the following text.

The step S201 forms an array substrate, which may comprise data lines, scan lines, thin film transistors and pixel electrodes. The array substrate comprises a display area to show images and a non-display area to distinguish or separate different pixels. When a metal layer is applied to form data lines or scan lines of the array substrate, the same metal layer is also installed in the non-display area of the array substrate, such as a first metal layer of the data lines or a second metal layer of the scan lines. It can block the light from leaking from the non-display area and thus prevent occurrences of light leakage. Then take step S202.

The step S202 patterns the black matrix in the display area of the array substrate with a slit coating machine. Thus a photolithography machine can align the black matrix through the non-display area of the array substrate, and undertakes accurate patterning of the black matrix. Then take step S203.

The step S203 installs photoresist in the display area of the array substrate. More specifically, a layer of photoresist is coated on the array substrate, and then the photoresist layer is patterned by a corresponding lithographic photomask, so to form a corresponding photoresist in the display area of the array substrate. The photoresist comprises red photoresist, blue photoresist and green photoresist.

Given that the metal layer installed in the non-display area of the array substrate may reflect and thus influence the light emitted from the back light source, the step S203 of the present preferred embodiment installs photoresist on the metal layer in the non-display area of the array substrate to shield light. The photoresist can better absorb the light emitted from the back light source, so to prevent the metal layer from reflecting the emitted light from the back light source. The light-shielding photoresist comprises, but is not limited to, the following combinations: a three-layer structure of red photoresist, blue photoresist and green photoresist; a two-layer structure of red photoresist and blue photoresist on both sides; a two-layer structure of red photoresist and green photoresist on both sides. All spectrums of the light emitted can be better absorbed if the light-shielding photoresist installed is a three-layer structure comprising red photoresist, blue photoresist and green photoresist.

The light-shielding photoresist is a layered structure of photoresists, whereas the photoresist of the display area only comprises a single-color photoresist layer, therefore the light-shielding photoresist is higher than the photoresist of the display area. It can reduce the amount of liquid crystal used for the corresponding liquid crystal panel.

Based on the first preferred embodiment, the method of forming the BOA substrate of the present preferred embodiment installs a photoresist to shield the light on the metal layer in the non-display area of the BOA substrate. It prevents an influence on the emitted light caused by the light reflected by the metal layer, and further enhances the display quality of the corresponding liquid crystal panel.

Please refer to FIG. 3. FIG. 3 is a flow chart of the method forming the BOA substrate according to a third preferred embodiment of the present invention. The method of forming the BOA substrate of the present preferred embodiment comprises:

Step S301: Form an array substrate comprising a display area and a non-display area.

Step S302: Coat a black matrix in the display area of the array substrate and pattern the black matrix.

Step S303: Deposit a photoresist on the array substrate. The photoresist in the non-display area of the array substrate is installed to shield light, so to prevent light from leaking from the non-display area.

A specific explanation of steps of the method forming the BOA substrate of the present preferred embodiment is provided in the following text.

In the step S301, form an array substrate, which may comprise data lines, scan lines, thin film transistors and pixel electrodes. The array substrate comprises a display area to show images and a non-display area to distinguish or separate different pixels. Then take step S302.

In, the step S302, pattern the black matrix in the display area of the array substrate with a slit coating machine. Thus a photolithography machine can align the black matrix through the non-display area of the array substrate, and undertakes accurate patterning of the black matrix. Then take step S303

In the step S303, deposit photoresist in the display area of the array substrate. More specifically, a layer of photoresist is coated on the array substrate, and then the photoresist layer is patterned by a corresponding lithographic photomask, so to form a corresponding photoresist in the display area of the array substrate. The photoresist comprises red photoresist, blue photoresist and green photoresist

The step S303 of the present preferred embodiment also installs light-shielding photoresist in the non-display area of the array substrate. The photoresist can better absorb the light emitted from the back light source, so to prevent light leakage in the non-display area of the array substrate. The light-shielding photoresist comprises, but is not limited to, the following combinations: a three-layer structure of red photoresist, blue photoresist and green photoresist; a two-layer structure of red photoresist and blue photoresist on both sides; a two-layer structure of red photoresist and green photoresist on both sides. All spectrums of the light emitted can be better absorbed if the light-shielding photoresist installed is a three-layer structure comprising red photoresist, blue photoresist and green photoresist, so to best prevent light leakage in the non-display area.

The light-shielding photoresist is a layered structure of photoresists, whereas the photoresist of the display area only comprises a single-color photoresist layer, therefore the light-shielding photoresist is higher than the photoresist of the display area. It can reduce the amount of liquid crystal used for the corresponding liquid crystal panel.

The method of forming the BOA substrate of the present preferred embodiment installs the black matrix only in the display area of the BOA substrate. Therefore it is less likely to cause a misalignment of the array substrate and color filter. And, the non-display area of the BOA substrate is installed with the light-shielding photoresist to prevent light leakage.

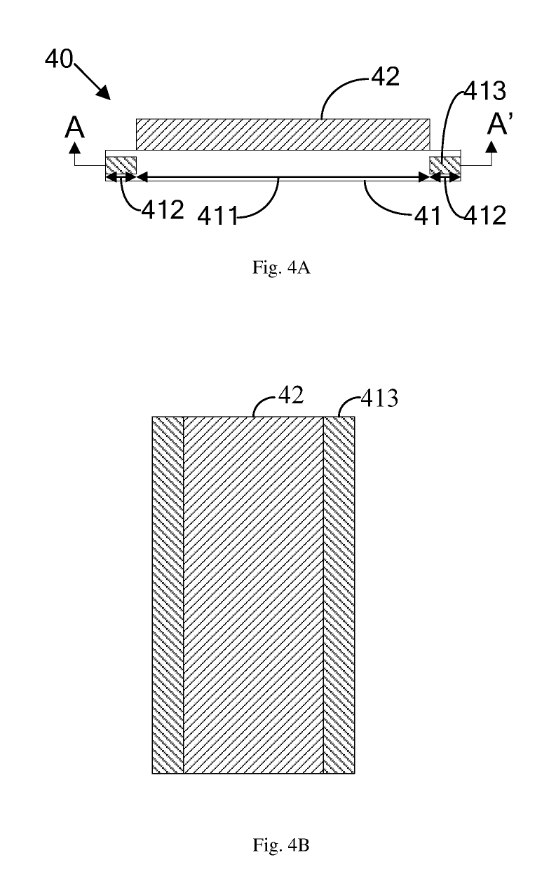

Please refer to FIG. 4A and 4B. FIG. 4A is a diagram of the BOA substrate according to the first preferred embodiment of the present invention. FIG. 4B shows a cross-sectional view along a line A-A′. The BOA substrate 40 of the present preferred embodiment comprises an array substrate 41 and a color filter 42 (comprising a black matrix and a photoresist layer). The array substrate 41 comprises a display area 411 to show images and a non-display area 412 to separate different pixels. The color filter 42 is installed in the display area of the array substrate 41 to transform the light emitted from the BOA substrate 40 into various monochromatic lights, and absorb light emitted from the non-display area 412 of the array substrate 40. The color filter 42 comprises red photoresist, blue photoresist, green photoresist, and a black matrix. The non-display area 412 of the array substrate 41 is further installed with a metal layer 413 to prevent light leakage in the non-display area.

BOA substrate 40 only installs the color filter 42 in the display area 411, therefore it is fitted to undertake patterning of the black matrix and install corresponding photoresist. Meanwhile, the metal layer installed correspondingly in the non-display area 412 can effectively block the light emitted from the back light source to leak from the non-display area 412, so to prevent light leakage.

The BOA substrate 40 only installs the color filter in the display area of the BOA substrate, thus it is less likely to cause a misalignment of the array substrate and the color filter. And, the metal layer installed in the non-display area of the BOA substrate prevents occurrences of light leakage.

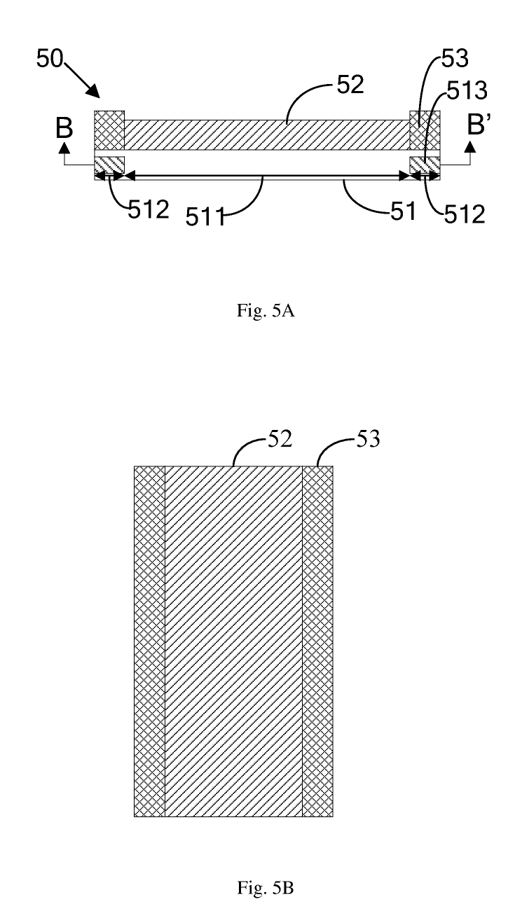

Please refer to FIG. 5A and FIG. 5B. FIG. 5A shows a diagram of a BOA substrate according to a second preferred embodiment of the present invention. FIG. 5B is a cross-sectional view along a line B-B′ in FIG. 5A. The BOA substrate 50 comprises an array substrate 51, color filter 52 (comprising a black matrix and a photoresist layer), and a light-shielding color resist layer 53. The array substrate 51 comprises a display area 511 to show images and a non-display area 512 to separate different pixels. The color filter 52 is installed in the display area 511 of the array substrate 51 to transform the light emitted from the BOA substrate 50 into various monochromatic lights, and absorb light emitted from the non-display area 512 of the array substrate 50. The color filter 52 comprises red photoresist, blue photoresist, green photoresist and a black matrix. The non-display area 512 of the array substrate 51 is further installed with a metal layer 513 to prevent light leakage in the non-display area. The light-shielding color resist layer 53 is installed on the metal layer 513 in the non-display area 512 of the array substrate 51.

Given that the metal layer 513 installed in the non-display area 512 might reflect and thus influence the light emitted from the back light source, the BOA substrate 50 installs the color resist layer 53 (a photoresist) on the metal layer 513 in the non-display area 512 to shield light. The light-shielding color resist layer 53 can better absorb the light emitted from the back light source, and prevent the metal layer 513 from reflecting the light emitted from the back light source. The color resist layer 53 comprises, but is not limited to, the following combinations: a three-layer structure of red photoresist, blue photoresist and green photoresist; a two-layer structure of red photoresist and blue photoresist on both sides; a two-layer structure of red photoresist and green photoresist on both sides. All spectrums of the light emitted can be better absorbed if the light-shielding color resist layer 53 installed is a three-layer structure comprising red photoresist, blue photoresist and green photoresist, so to best prevent light leakage in the non-display area.

The light-shielding color resist layer 53 is a layered structure of photoresists, whereas the color filter 52 of the display area only comprises a single-color photoresist layer, therefore the light-shielding color resist layer 53 is higher than the color filter 52. It can reduce the amount of liquid crystal used for the corresponding liquid crystal panel.

The metal layer in the non-display area of the BOA substrate 50 is installed with the light-shielding color resist layer to shield light, and prevent the influence of the light reflected by the metal layer on the emitted light. It further enhances the display quality of the corresponding LCD panel.

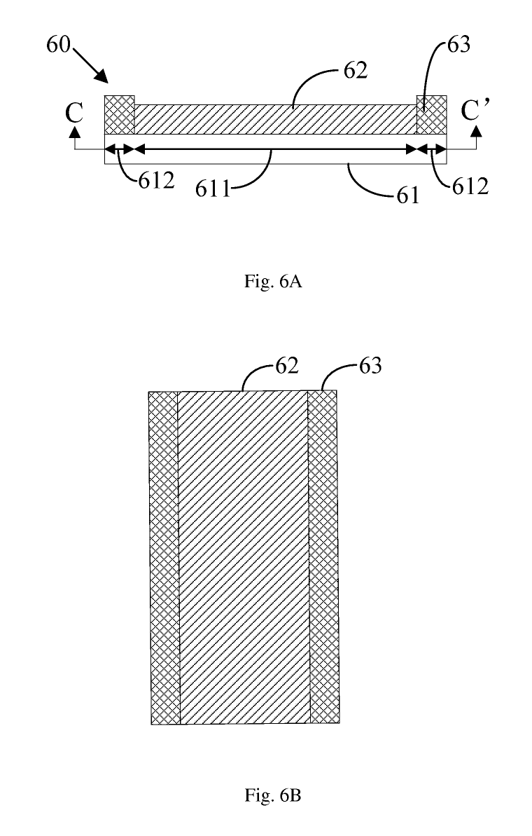

Please refer to FIG. 6A and FIG. 6B. FIG. 6A is a diagram of the BOA substrate according to a third preferred embodiment of the present invention. FIG. 6B is a cross-sectional view along a line C-C′ in FIG. 6A. BOA substrate 60 comprises an array substrate 61, a color filter 62 (comprising a black matrix and a photoresist layer) and a light-shielding color resist layer 63. The array substrate 61 comprises a display area 611 to show images, and a non-display area 612 to separate different pixels. The color filter 62 is installed in the display area 611 of the array substrate 61 to transform the light emitted from the BOA substrate 60 into various monochromatic lights, and absorb light emitted from the non-display area 612 of the array substrate 60. The color filter 62 comprises red photoresist, blue photoresist, green photoresist and a black matrix. The light-shielding color resist layer 63 is installed in the non-display area 612 of the array substrate 61.

The present preferred embodiment installs the light-shielding color resist layer 63 in the non-display area 612 of the BOA substrate 60. The light-shielding color resist layer 63 can better absorb the light emitted from the back light source, and prevent light leakage in the non-display area 612 of the BOA substrate 60. The color resist layer 63 comprises, but is not limited to, the following combinations: a three-layer structure of red photoresist, blue photoresist and green photoresist; a two-layer structure of red photoresist and blue photoresists on both sides; a two-layer structure of red photoresist and green photoresist on both sides. All spectrums of the light emitted can be better absorbed if the light-shielding color resist layer 63 installed is a three-layer structure comprising red photoresist, blue photoresist and green photoresist, so to best prevent light leakage in the non-display area.

The light-shielding color resist layer 63 is a layered structure of photoresists, whereas the color filter 62 of an area only comprises a single-color photoresist layer, therefore the light-shielding color resist layer 63 is higher than the color filter 62. It can reduce the amount of liquid crystal used for the corresponding liquid crystal panel

The BOA substrate 60 installs the black matrix only in the display area, therefore it is less likely to cause misalignment of the array substrate and the color filter. And, the non-display area of the BOA substrate is installed with a light-shielding color resist layer to shield light, so to prevent the occurrences of light leakage.

The method of forming the BOA substrate and the BOA substrate of the present invention installs the black matrix only in the display area of the BOA substrate, therefore it is less likely to cause a misalignment of the array substrate and color filter. It solves the existing technical problem with the conventional method of forming BOA substrates and BOA substrates that is more likely to cause misalignment of array substrate and color filter, which further influences the display quality of the LCD panel.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A method of forming a black matrix on array (BOA) substrate, comprising:
forming an array substrate, wherein the array substrate comprises a display area and a non-display area, which is installed with a metal layer to prevent light leakage in the non-display area; and
coating a black matrix in the display area and patterning the black matrix.

2. The method of claim 1, wherein after patterning the black matrix the method further comprises:
coating a photoresist layer on the array substrate and patterning the photoresist layer so to form a photoresist on the array substrate.

3. The method of claim 2, wherein the photoresist comprises red photoresist, blue photoresist and green photoresist.

4. The method of a BOA substrate of claim 2, wherein the step of coating photoresist on the array substrate comprises:
installing the photoresist to shield light in the non-display area of the array substrate.

5. The method of claim 4, wherein the photoresist to shield light is a layered structure of red photoresist, green photoresist and blue photoresist.

6. The method of claim 4, wherein the photoresist to shield light is a layered structure of red photoresist and blue photoresist.

7. The method of claim 4, wherein the photoresist to shield light is a layered structure of red photoresist and green photoresist.

8. A method of forming a BOA substrate, comprising:
forming an array substrate comprising a display area and a non-display area;
coating a black matrix in the display area of the array substrate, and patterning the black matrix; and
installing photoresist on the array substrate, wherein the photoresist is installed in the non-display area of the array substrate shields light and prevents light leakage in the non-display area.

9. The method of claim 8, wherein the step of installing photoresist on the array substrate comprises:
coating a photoresist layer on the array substrate, and patterning the photoresist layer so to form a photoresist on the array substrate.

10. The method of claim 9, wherein the photoresist comprises red photoresist, blue photoresist and green photoresist.

11. The method of claim 9, wherein the photoresist to shield light is a layered structure of red photoresist, green photoresist and blue photoresist.

12. The method of claim 9, wherein the photoresist to shield light is a layered structure of red photoresist and blue photoresist.

13. The method of claim 9, wherein the photoresist to shield light is a layered structure of red photoresist and green photoresist.

14. A BOA substrate, comprising:
an array substrate, comprising a display area to show images and a non-display area to separate different pixels;
a black matrix, installed in the display area of the array substrate to absorb light emitted from the non-display area of the array substrate;
wherein the non-display area of the array substrate is installed with a metal layer to prevent light leakage in the non-display area.

15. The BOA substrate of claim 14, further comprising:
a photoresist layer, comprising red photoresist, blue photoresist and green photoresist, installed in the display area of the array substrate to transform the light emitted from the BOA substrate into various monochromatic lights; and
a light-shielding color resist layer, installed on the metal layer in the non-display area of the array substrate.

16. The BOA substrate of claim 15, wherein the light-shielding color resist layer is a layered structure of red photoresist, green photoresist and blue photoresist.

17. The BOA substrate of claim 15, wherein the light-shielding color resist layer is a layered structure of red photoresist and blue photoresist.

18. The BOA substrate of claim 15, wherein light-shielding color resist layer is a layered structure of red photoresist and green photoresist.
